(19) United States
(12) Patent Application Publication
(10) Pub. No.: US 2007/0292625 A1
(43) Pub. Date: Dec. 20, 2007

(54) Automotive part print design process

(76) Inventors: Jerry Leslie, Vancouver, WA (US); Paul Stringer, Vancouver, WA (US)

Correspondence Address: K.M. RYLANDER;RYLANDER & ASSOCIATES, 406 West 12th Street, Vancouver, WA, 98660, US

(21) Appl. No.: 11/471,422

(22) Filed: Jun. 19, 2006

(51) Int. Cl. B05D 1/18; B05D 7/00; B05D 3/02; B05D 1/12

(52) U.S. Cl. 427/421.1; 427/430.1; 427/372.2; 427/180; 427/299

(57) ABSTRACT

An automotive part print design process utilizing ink includes the steps of cleaning an automotive part in an acid bath, printing a chosen design on water-soluble film using a high temperature ink that can withstand temperatures of up to 500 degrees F. (260 degrees C.), activating the print by wetting the film in a polyester resin solution to activate the inks, floating the activated film on water, dipping the automotive part into the activated film, shaking the water off the part, washing the automotive part to remove the film, drying the automotive part, preferably in a wind tunnel, performing at least one cycle of spray coating the automotive part with a transparent top coat of powder polyurethane and drying the spray coated automotive part, baking the part in a convection oven at 150 degrees F. (65.55 degrees C.) for 60 minutes, and drying the automotive part in ambient air.

### FIELD OF THE INVENTION

The present invention relates to liquid pressure transfer printing. More particularly, the present invention relates to liquid pressure transfer printing of designs on exposed automotive parts.

### BACKGROUND

Decorated exterior automotive parts, such as wheels, hubcaps, running boards, and steps, are an attractive feature of an automobile. Normal decoration techniques include painting on the automotive part, or putting decals or stickers on the automotive part, or structurally sculpting the automotive part. A mass produced process for creating different designs and easily putting them on select exterior automotive parts utilizing ink rather than paints or decals would be an advantage. While ink design technology has been used for parts on the inside of an automobile, it has not been utilized on parts outside of an automobile such as a wheel or hubcap.

The following represents a list of known related art:

| Reference: | Issued to: | Date of Issue: |
|---|---|---|
| U.S. Pat. No. 6,022,438 | Watanabe et al. | Feb. 8, 2000 |
| U.S. Pat. No. 6,437,023 | Otaki, et al. | Aug. 20, 2002 |
| U.S. Pat. No. 6,551,392 | Otaki, et al. | Apr. 22, 2003 |
| U.S. Pat. No. 6,497,779 | Suzuki, et al. | Dec. 24, 2002 |
| U.S. Pat. No. 6,554,940 | Otaki, et al. | Apr. 29, 2003 |
| U.S. Pat. No. 6,599,579 | Kiyotaki | Jul. 29, 2003 |
| U.S. Pat. No. 6,103,342 | Niwa, et al. | Aug. 15, 2000 |
| U.S. Pat. No. 6,408,743 | Niwa, et al. | Jun. 25, 2002 |
| U.S. Pat. No. 5,925,452 | Niwa, et al. | Jul. 20, 1999 |
| U.S. Pat. No. 5,916,502 | Niwa, et al. | Jun. 29, 1999 |

The teachings of each of the above-listed citations (which does not itself incorporate essential material by reference) are herein incorporated by reference. None of the above inventions and patents, taken either singularly or in combination, is seen to describe the instant invention as claimed.

### SUMMARY AND ADVANTAGES

An automotive part print design process utilizing ink includes the steps of cleaning an automotive part in an acid bath, printing a chosen design on water-soluble film using a high temperature ink that can withstand temperatures of up to 500 degrees F. (260 degrees C.), activating the print by wetting the film in a polyester resin solution to activate the inks, floating the activated film on water, dipping the automotive part into the activated film, shaking the water off the part, washing the automotive part to remove the film, drying the automotive part, preferably in a wind tunnel, performing at least one cycle of spray coating the automotive part with a transparent top coat of powder polyurethane and drying the spray coated automotive part, baking in a convection oven at 150 degrees F. (65.55 degrees C.) for 60 minutes, and drying the automotive part in ambient air.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows the flow chart for the process of wheel or hubcap print design utilizing inks.

FIG. 2 shows an automotive part, a wheel, printed in accordance with the present invention.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

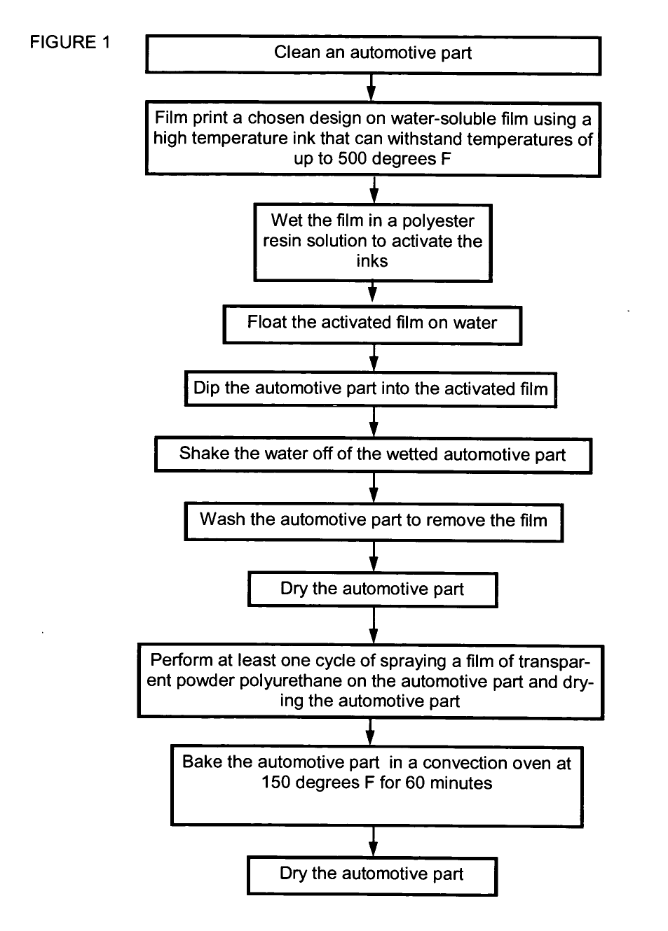

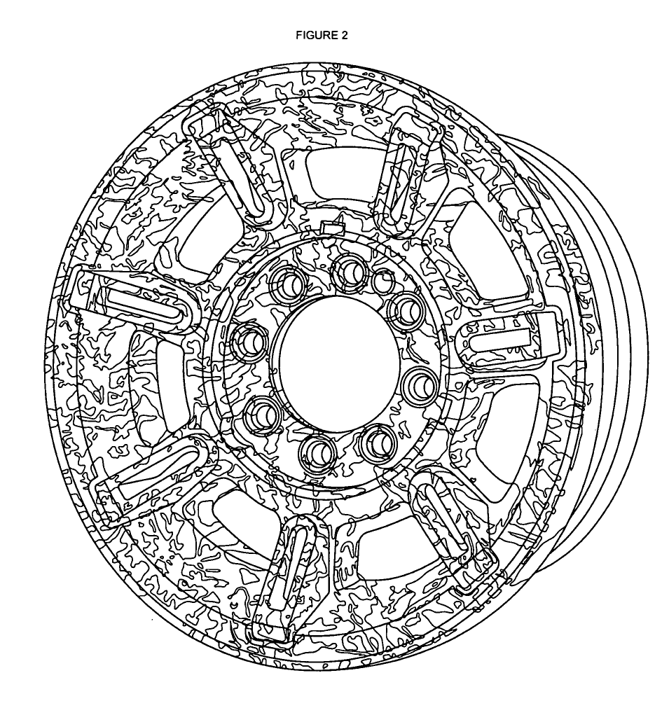

A graphics print design process for automotive parts outside of the vehicle. Printing decoration technology uses water-soluble film to apply a pattern to any complex part. In this case, aftermarket wheels, bumpers, running boards, etc. can be designed with camouflage, salmon or logos or other designs. As shown in FIG. 1, the graphics print design process includes steps of film printing by printing a chosen design on water-soluble film, activating the print by wetting the film in a polyester resin solution to activate the inks, transferring the activated film by floating the activated film on water and then dipping the automotive part, such as a wheel, into the activated film, shaking the water off, washing the automotive part to remove the film an this also bonds the ink to the surface of the automotive part, drying the automotive part, preferably in a wind tunnel, coating the automotive part with a transparent top coat to seal the printed surface, preferably by spraying a film of transparent powder polyurethane on the automotive part and then baking the parts in a convection oven at 150 degrees F. (65.55 degrees C.) for 60 minutes. Both the ink and the solvents chosen utilize adhesive properties that are stable as long as they stay dry. The designs chosen are preferably repeating patters, as seen by the camouflaged wheel shown in FIG. 2 printed according to the present invention.

An automotive part print design process utilizing ink includes the steps of cleaning an automotive part in an acid bath, printing a chosen design on water-soluble film using a high temperature ink that can withstand temperatures of up to 500 degrees F. (260 degrees C.), activating the print by wetting the film in a polyester resin solution to activate the inks, floating the activated film on water, dipping the automotive part into the activated film, shaking the water off the part, washing the automotive part to remove the film, drying the automotive part, preferably in a wind tunnel, performing at least one cycle of spray coating the automotive part with a transparent top coat of powder polyurethane and drying the spray coated automotive part, baking the part in a convection oven at 150 degrees F. (65.55 degrees C.) for 60 minutes, and drying the automotive part in ambient air.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

We claim:

1. An automotive part print design process utilizing ink, comprising steps of:
cleaning an automotive part in an acid bath;
printing a chosen design on water-soluble film using a high temperature ink that can withstand temperatures of up to 500 degrees F. (260 degrees C.);
activating the print by wetting the film in a polyester resin solution to activate the inks;
floating the activated film on water;
dipping the automotive part into the activated film;
shaking the water off the part;
washing the automotive part to remove the film;
drying the automotive part;
performing at least one cycle of spray coating the automotive part with a transparent top coat of powder polyurethane and drying the spray coated automotive part;
baking said part in a convection oven at 150 degrees F. (65.55 degrees C.) for 60 minutes; and
drying the automotive part in ambient air.

2. The process of claim 1, wherein two cycles of spray coating are performed.

3. The process of claim 1 or 2, wherein the part is dried after washing in a wind tunnel.

4. The process of claim 1 or 2, where the automotive part is selected from the group consisting of hubcaps, wheels, automotive steps, running boards, doors, fenders, hoods, trunk hoods.

5. The process of claim 4, wherein the part is dried after washing in a wind tunnel.

6. An automotive part print design process utilizing ink, comprising steps of:
cleaning an automotive part in an acid bath, where the automotive part is selected from the group consisting of hubcaps, wheels, automotive steps, running boards, doors, fenders, hoods, trunk hoods;
printing a chosen design on water-soluble film using a high temperature ink that can withstand temperatures of up to 500 degrees F. (260 degrees C.);
activating the print by wetting the film in a polyester resin solution to activate the inks;
floating the activated film on water;
dipping the automotive part into the activated film;
shaking the water off the part;
washing the automotive part to remove the film;
drying the automotive part in a wind tunnel;
performing two cycles of spray coating the automotive part with a transparent top coat of powder polyurethane and drying the spray coated automotive part;
baking said part in a convection oven at 150 degrees F. (65.55 degrees C.) for 60 minutes; and
drying the automotive part in ambient air.
